(19) United States
(12) Patent Application Publication
(10) Pub. No.: US 2025/0270121 A1
(43) Pub. Date: Aug. 28, 2025

(54) WASTEWATER TREATMENT SYSTEM FOR SEMICONDUCTOR FABRICATION PROCESS AND WASTEWATER TREATMENT METHOD USING THE SAME

(71) Applicant: SAMSUNG ELECTRONICS CO., LTD., Suwon-si (KR)

(72) Inventors: HONGSIK YOON, Suwon-si (KR); Seongsoo Kim, Suwon-si (KR); Dasom Oh, Suwon-si (KR); Seonghwan Kim, Suwon-si (KR); Taijin Min, Suwon-si (KR)

(73) Assignees: SAMSUNG ELECTRONICS CO., LTD., Suwon-si (KR); KOREA INSTITUTE OF MACHINERY & MATERIALS, Daejeon (KR)

(21) Appl. No.: 18/927,311

(22) Filed: Oct. 25, 2024

(30) Foreign Application Priority Data
Feb. 26, 2024 (KR) 10-2024-0027578
Mar. 25, 2024 (KR) 10-2024-0040333

(51) Int. Cl. C02F 1/469; C02F 1/44; C02F 1/461; C02F 103/34

(52) U.S. Cl. CPC C02F 1/4691; C02F 1/444; C02F 1/46109; C02F 2001/46133; C02F 2103/346; C02F 2201/46135; C02F 2201/46145

(57) ABSTRACT

Wastewater treatment systems and methods are provided. The wastewater treatment system may include a filtration device that filters a semiconductor fabrication wastewater, and a first capacitive deionization device and a second capacitive deionization device that are connected in parallel to the filtration device. One from among the first capacitive deionization device and the second capacitive deionization device may produce deionized water. Simultaneously, the other from among the first capacitive deionization device and the second capacitive deionization device may produce concentrated water.

### CROSS-REFERENCE TO RELATED APPLICATIONS

This U.S. non-provisional application claims priority under 35 U.S.C § 119 to Korean Patent Applications No. 10-2024-0027578, filed on Feb. 26, 2024, and No. 10-2024-0040333, filed on Mar. 25, 2024, in the Korean Intellectual Property Office, the disclosures of which are hereby incorporated by reference in their entireties.

### BACKGROUND

### 1. Field

Embodiments of the present disclosure relate to a wastewater treatment system for semiconductor fabrication process and a wastewater treatment method using the same, and more particularly, to a wastewater treatment system capable of treating (or deionizing) and concentrating a wastewater generated during semiconductor fabrication process and a wastewater treatment method using the same.

### 2. Brief Description of Related Art

Various processes may be performed to fabricate a semiconductor device. For example, the semiconductor device may be fabricated by performing a photolithography process, an etching process, and a deposition process. For example, a hydrofluoric acid is used in an etching process for removing a silicon oxide layer. Thus, a semiconductor fabrication wastewater may include fluorine. Fluorine may be harmful to humans and may cause environmental issues. Therefore, to remove or reduce fluorine, calcium hydroxide (Ca(OH)₂) may be added to the semiconductor fabrication wastewater such that fluorine and calcium may be combined with each other to remove fluorine.

### SUMMARY

Some embodiments of the present disclosure provide a wastewater treatment system capable of decreasing hardness of wastewater and increasing process efficiency and a wastewater treatment method using the same.

According to some embodiments of the present disclosure, a wastewater treatment system may be provided and include: a filter that is configured to filter a semiconductor fabrication wastewater; and a first capacitive deionizer and a second capacitive deionizer that are connected in parallel to the filter, wherein one from among the first capacitive deionizer and the second capacitive deionizer is configured to produce deionized water while the other from among the first capacitive deionizer and the second capacitive deionizer is configured to simultaneously produce concentrated water.

According to some embodiments of the present disclosure, a wastewater treatment system may be provided and include: a filter configured to filter a semiconductor fabrication wastewater; at least one capacitive deionizer connected to the filter and configured to produce deionized water; a membrane bioreactor connected to the at least one capacitive deionizer; and at least one controller, wherein the at least one capacitive deionizer includes: a chamber that includes an inlet port and an outlet port; a plurality of electrode pairs in the chamber, each of the plurality of electrode pairs including a first electrode plate and a second electrode plate that are adjacent to each other, wherein the at least one controller is configured to adjust a voltage applied to the first electrode plate and the second electrode plate, and wherein the at least one controller is configured to cause a difference in voltage between the first electrode plate and the second electrode plate of the at least one capacitive deionizer to be in a range of 1.0 V to 1.5 V while the at least one capacitive deionizer produces the deionized water.

According to some embodiments of the present disclosure, a wastewater treatment method may be provided and include: filtering, by a filter, particulate materials in a semiconductor fabrication wastewater; producing, by a first capacitive deionizer, deionized water; producing, by a second capacitive deionizer, concentrated water; and supplying a membrane bioreactor with the deionized water.

Aspects of embodiments of the present disclosure are not limited to the aspects mentioned above, and other aspects which have not been mentioned above will be clearly understood to those skilled in the art from the following description.

### BRIEF DESCRIPTION OF DRAWINGS

FIG. 1 illustrates a simplified schematic diagram showing a wastewater treatment system for a semiconductor fabrication process according to some embodiments of the present disclosure.

FIG. 2A illustrates a simplified cross-sectional view showing a first capacitive deionization device and a second capacitive deionization device of FIG. 1.

FIG. 2B illustrates a simplified diagram showing production of deionized water from one of a first capacitive deionization device and a second capacitive deionization device.

FIG. 2C illustrates a simplified diagram showing production of concentrated water from one of a first capacitive deionization device and a second capacitive deionization device.

FIG. 3 illustrates a graph showing a change in electrical conductivity of wastewater according to some embodiments of the present disclosure.

FIG. 4 illustrates a flow chart showing a wastewater treatment method for a semiconductor fabrication process according to some embodiments of the present disclosure.

FIG. 5A illustrates a graph showing how a first capacitive deionization device operates over time.

FIG. 5B illustrates a graph showing how a second capacitive deionization device operates over time.

FIG. 6 illustrates a graph showing how ion removal rates depend on kinds of cation and operating voltages of capacitive deionization devices according to some embodiments of the present disclosure.

FIG. 7 illustrates a graph showing how ion removal rates depend on kinds of cation and recovery rates of capacitive deionization devices according to some embodiments of the present disclosure.

### DETAILED DESCRIPTION

Non-limiting example embodiments of the present disclosure will now be described in detail with reference to the accompanying drawings to aid in clearly explaining the present disclosure. In this description, such terms as “first” and “second” may be used to simply distinguish identical or similar components from each other, and the sequence of such terms may be changed in accordance with the order of mention. In this description, the term “desalted” may be called “deionized.” The language “deionized water” may be called “desalted water” or “produced water.”

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

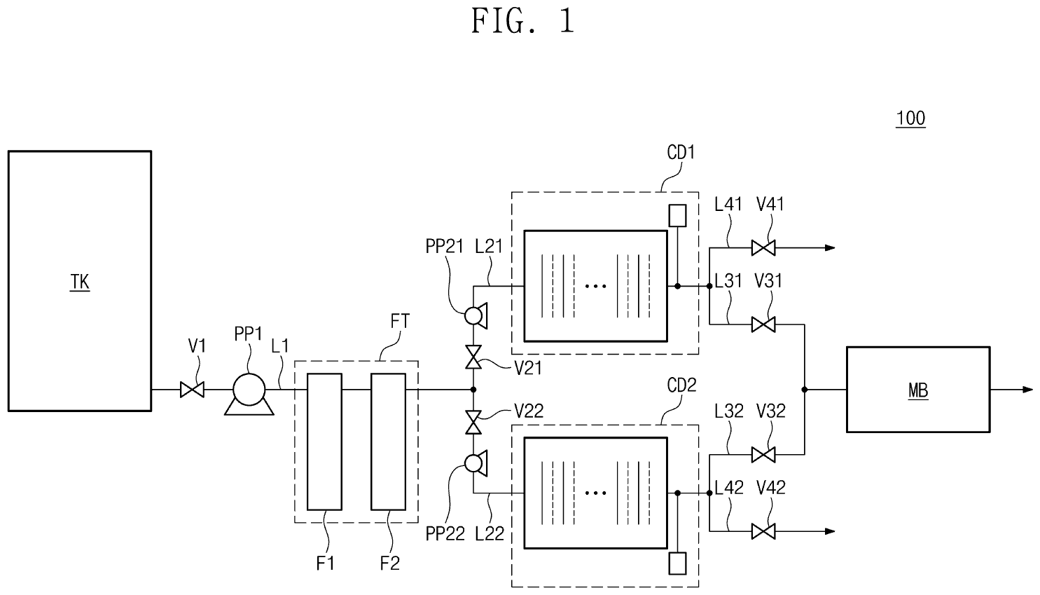

FIG. 1 illustrates a simplified schematic diagram showing a wastewater treatment system for a semiconductor fabrication process according to some embodiments of the present disclosure.

Referring to FIG. 1, a wastewater treatment system 100 for a semiconductor fabrication process may be provided. The wastewater treatment system 100 may treat a wastewater produced during the semiconductor fabrication process. For example, the wastewater treatment system 100 may treat a wastewater discharged during an etching process, a photolithography process, and/or a cleaning process.

The wastewater treatment system 100 may include a storage tank TK, a filtration device FT, capacitive deionization devices (e.g., a first capacitive deionization device CD1 and a second capacitive deionization device CD2), and a membrane bioreactor MB.

For example, the storage tank TK may store a semiconductor fabrication wastewater. The wastewater may include a monovalent cation such as a sodium ion (Na⁺) and an ammonium ion (NH₄⁺), a divalent cation such as a calcium ion (Ca²⁺) and a magnesium ion (Mg²⁺), a monovalent anion such as a fluorine ion (F⁻) and hydroxide ion (OH⁻), and/or a divalent anion such as a sulfate ion (SO₄²⁻). An amount (concentration) of the monovalent cation in the wastewater may be greater than an amount (concentration) of the divalent cation in the wastewater. For example, the wastewater may include calcium ions (Ca²⁺) whose concentration is in a range of about 200 mg/L to about 300 mg/L.

During the semiconductor fabrication process, a hydrofluoric acid may be used in an etching process for removing a silicon oxide layer. Thus, the wastewater may include fluorine. Fluorine may be harmful to humans and may cause environmental issues. Therefore, the wastewater may be added with calcium hydroxide (Ca(OH)₂) to remove or reduce fluorine. As described in the Chemical Equation below, fluorine and potassium may be combined to form CaF₂, and CaF₂ may be agglutinated (or precipitated) and filtered to remove fluorine.

2HF+Ca(OH)₂→CaF₂+2H₂O [Chemical Equation]

Calcium ions (Ca²⁺) produced from calcium hydroxide (Ca(OH)₂) may partially remain in the wastewater such that hardness of the wastewater may be increased to induce severe issues such as clogging of pipelines, contamination of membranes, and reduction in efficiency of heat exchange. When a membrane bioreactor or an agitator is supplied with the wastewater containing a large amount of calcium ions (Ca²⁺), the calcium ions (Ca²⁺) may cause problems such as scale formation.

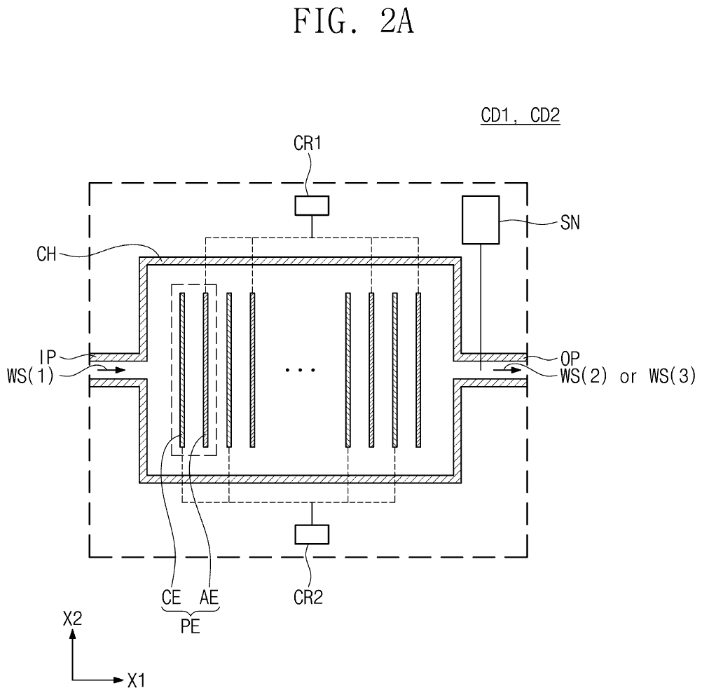

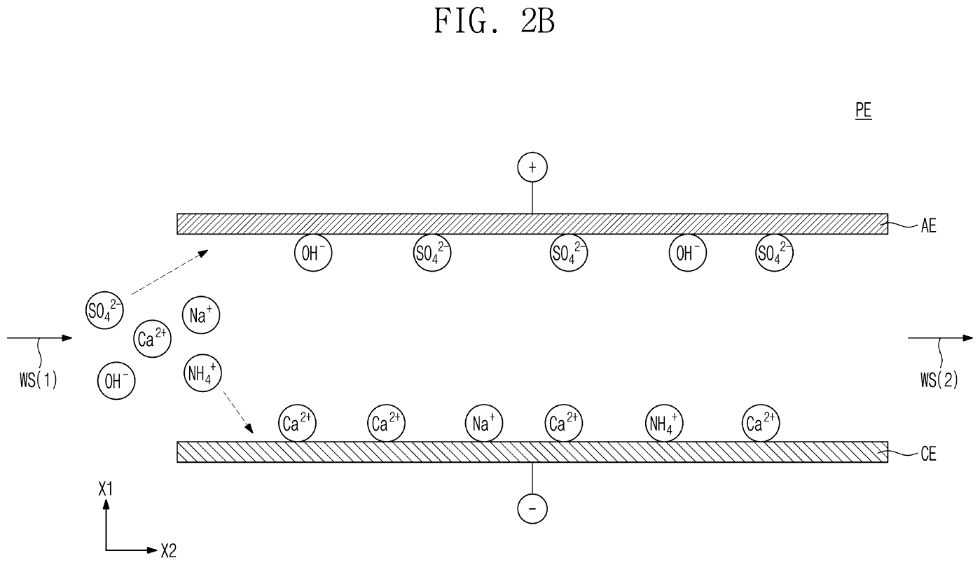

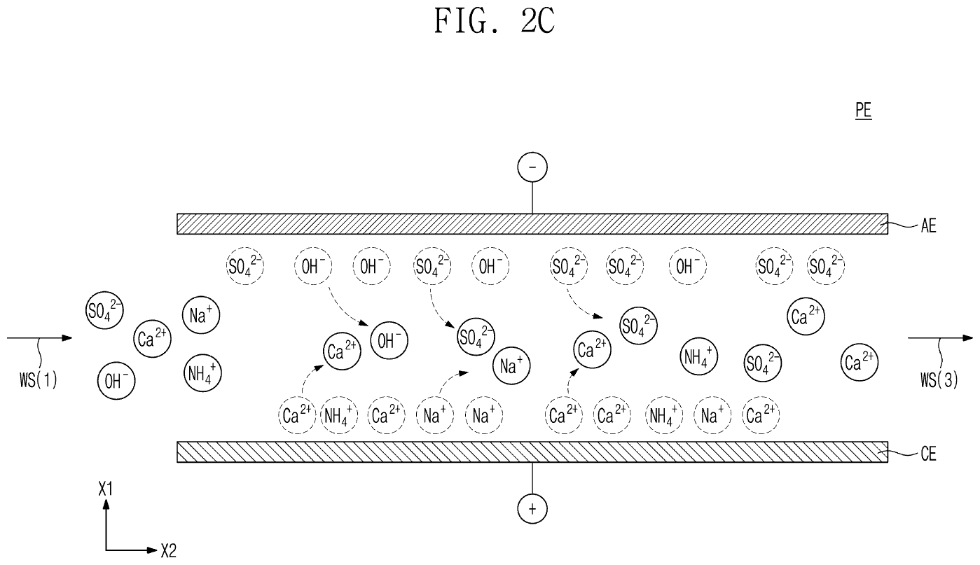

A first valve V1 and a first pump PP1 may be installed on a first connection line L1 that connects the storage tank TK to the filtration device FT, and may adjust a flow speed or amount of the wastewater (e.g., wastewater WS(1) of FIG. 2A) discharged from the storage tank TK.

The filtration device FT may filter and remove particulate materials (e.g., inorganic materials, organic materials, or large-particle materials) or CaF₂ included in the wastewater. The filtration device FT may include a plurality of filtering units. The plurality of filtering units may be connected in series and/or in parallel to each other.

For example, the filtering units may include a first filtering unit F1 and a second filtering unit F2 that are connected in series to each other. The first filtering unit F1 may include a first filter having a first pore size. The second filtering unit F2 may include a second filter having a second pore size. Both of the first filter and the second filter may be formed of, for example, fabric. For example, the first pore size may range from about 0.6 μm to about 3 μm, and the second pore size may range from about 0.1 μm to about 0.5 μm. The wastewater may be filtered in the first filtering unit F1 and then filtered in the second filtering unit F2. The number of the filtering units may be three or more without being limited to two.

A plurality of capacitive deionization devices (e.g., the first capacitive deionization device CD1 and the second capacitive deionization device CD2) may be connected in parallel to the filtration device FT. The plurality of capacitive deionization devices may include, for example, a first capacitive deionization device CD1 and a second capacitive deionization device CD2. In the present embodiment, the number of the capacitive deionization devices may be three or more without being limited to two.

A valve V21 and a pump PP21 may be disposed on a connection line L21 between the filtration device FT and the first capacitive deionization device CD1. A valve V22 and a pump PP22 may be disposed on a connection line L22 between the filtration device FT and the second capacitive deionization device CD2. The valve V21 and the pump PP21 may adjust a flow rate of the wastewater introduced into the first capacitive deionization device CD1, and the valve V22 and the pump PP22 may adjust a flow rate of the wastewater introduced into the second capacitive deionization device CD2.

FIG. 2A illustrates a simplified cross-sectional view showing a first capacitive deionization device and a second capacitive deionization device of FIG. 1.

Referring to FIGS. 1 and 2A, each of the first capacitive deionization device CD1 and the second capacitive deionization device CD2 may include a chamber CH including an inlet port IP and an outlet port OP, and may also include a plurality of electrode pairs PE that are disposed side by side in a first direction X1 in the chamber CH. Each of the electrode pairs PE may include a first electrode plate AE and a second electrode plate CE that are adjacent to each other. The first electrode plate AE and the second electrode plate CE may have a vertical sections extending in a second direction X2 that intersects the first direction X1. The first electrode plate AE and the second electrode plate CE may have a circular or polygonal disk shape when viewed in a plan view. Each of the first electrode plate AE and the second electrode plate CE may be formed of carbon, graphene, graphite, or activated carbon. For example, the number of the electrode pairs PE may be in a range of about 100 to about 300. Each of the first capacitive deionization device CD1 and the second capacitive deionization device CD2 may include about 100 to 300 first electrode plates AE and about 100 to 300 second electrode plates CD. The number of the electrode pairs PE may be variously changed without being limited thereto.

The first electrode plates AE and the second electrode plates CE may be alternately disposed in the chamber CH. The first electrode plates AE may be connected to a first voltage controller CR1. The first voltage controller CR1 may adjust a voltage applied to the first electrode plates AE. The second electrode plates CE may be connected to a second voltage controller CR2. The second voltage controller CR2 may adjust a voltage applied to the second electrode plates CE.

Alternatively, a first one of the first electrode plates AE may be connected to the first voltage controller CR1, and the remaining first electrode plates AE may be electrically charged. A last one of the second electrode plates CE may be connected to the second voltage controller CR2, and the remaining second electrode plates CE may be electrically charged.

An electrical conductivity sensor SN may be connected to the outlet port OP of the chamber CH. A wastewater WS(1) may enter the inlet port IP of the chamber CH, pass through between the first electrode plates AE and the second electrode plates CE, and may escape the outlet port OP of the chamber CH. Either deionized water WS(2) or concentrated water WS(3) may be produced depending on voltages applied to the first electrode plates AE and the second electrode plates CE.

For example, one from among the first capacitive deionization device CD1 and the second capacitive deionization device CD2 may use electrochemical adsorption-desorption to remove ions in a wastewater WS. When the ions are removed, any salt may not be produced to eventually exhibit a deionization effect.

FIG. 2B illustrates a simplified diagram showing production of deionized water from one of a first capacitive deionization device and a second capacitive deionization device. FIG. 2B depicts one electrode pair PE as an example.

For example, referring to FIG. 2B, when the first electrode plates AE are either connected to a positive electrode or provided with a positive voltage, and when the second electrode plates CE are either connected to a negative electrode or provided with a negative voltage, the second electrode plates CE may be adsorbed thereon with cations (e.g., a monovalent cation such as a sodium ion (Na⁺) or an ammonium ion (NH₄⁺) and a divalent cation such as a calcium ion (Ca²⁺) or magnesium ion (Mg²⁺)) in the wastewater WS(1), and the first electrode plates AE may be adsorbed thereon with anions (e.g., a monovalent anion such as fluorine ion (F⁻) or a hydroxide ion (OH⁻) and a divalent anion such as sulfate ion (SO₄²⁻)) in the wastewater WS(1). Based on the principle above, ions in the wastewater WS(1) may be removed to reduce an amount (concentration) included in a wastewater WS(2) discharged through the outlet port OP of the chamber CH, compared to the wastewater WS(1) introduced through the inlet port IP. Desalted water or deionized water may refer to the wastewater WS(2) from which ions are removed or whose concentration of ions is reduced as discussed above.

According to an embodiment of the present disclosure, calcium ions (Ca²⁺) in the wastewater WS(1) supplied to the first capacitive deionization device CD1 and the second capacitive deionization device CD2 may have a concentration of about 100 ppm to about 500 ppm, and calcium ions in the wastewater WS(2) may have a concentration of about 0 ppm to about 75 ppm. Sulfate ions (SO₄²⁻) in the wastewater WS(1) supplied to the first capacitive deionization device CD1 and the second capacitive deionization device CD2 may have a concentration of about 800 ppm to about 1,200 ppm, and sulfate ions in the wastewater WS(2) may have a concentration of about 0 ppm to about 400 ppm.

When the deionized water WS(2) is produced from one from among the first capacitive deionization device CD1 and the second capacitive deionization device CD2, a voltage difference of about 1.0 V to about 1.5 V may be provided between the first electrode plate AE and the second electrode plate CE of the one from among the first capacitive deionization device CD1 and the second capacitive deionization device CD2. When the number of the electrode pairs PE is less than 200, a difference between total voltages of the first electrode plates AE and total voltages of the second electrode plates CE (e.g., an operating voltage of each of first capacitive deionization device CD1 and the second capacitive deionization device CD2) may be about 200 V to about 300 V.

When the deionized water WS(2) is produced from the one from among the first capacitive deionization device CD1 and the second capacitive deionization device CD2, divalent cations (e.g., calcium ions (Ca²⁺) or magnesium ions (Mg²⁺)) may be removed more than monovalent cations (e.g., sodium ions (Na⁺) or ammonium ions (NH₄⁺)) from the wastewater WS(1). This may be caused by the fact that according to Coulomb's law (Coulomb's force) cations with a larger valence number are more strongly attracted to the second electrode plates CE.

In an embodiment of the present disclosure, a selectivity of calcium ion (Ca²⁺) to sodium ion (Na⁺) may be calculated using Mathematical Formula 1 below.

$${Ca}^{2 +} / {Na}^{+} selectivity ( = \frac{{Ca}_{feed}^{2 +}}{{Na}_{feed}^{+}} / \frac{{Ca}_{product}^{2 +}}{{Na}_{product}^{+}} ) . \qquad [ Mathematical Formula 1 ]$$

In Mathematical Formula 1, Ca²⁺_{feed} and Na⁺_{feed} may respectively indicate a concentration of calcium ion (Ca²⁺) and a concentration of sodium ion (Na⁺) supplied to the first capacitive deionization device CD1 and the second capacitive deionization device CD2. In Mathematical Formula 1, Ca²⁺_{product} and Na⁺_{product} may respectively indicate a concentration of calcium ion (Ca²⁺) and a concentration of sodium ion (Na⁺) discharged from the first capacitive deionization device CD1 and the second capacitive deionization device CD2. In embodiments of the present disclosure, the selectivity of calcium ion (Ca²⁺) to sodium ion (Na⁺) may be about 2 to about 3. It may thus be ascertained that, in embodiments of the present disclosure, divalent cations are selectively removed more than monovalent cations.

In embodiments of the present disclosure, a capacitive deionization device may be used to effectively remove calcium ions from wastewater produced during semiconductor fabrication process, and thus hardness of the wastewater may be controlled or reduced. Thus, it may be possible to solve issues such as clogging of pipelines, contamination of membranes, and reduction in efficiency of heat exchange. In addition, no scale may be formed in a membrane bioreactor and so forth.

A difference in voltage between the first electrode plate AE and the second electrode plate CE of the one from among the first capacitive deionization device CD1 and the second capacitive deionization device CD2 may be adjusted to about 1.0 V to about 1.5 V, which may result in an improvement in selectivity. In addition, a difference in voltage between the first electrode plate AE and the second electrode plate CE may be lowered to about 1.0 V to about 1.5 V, allowing operation at low power and mitigating degradation in an electrode plate.

When a voltage of less than about 1 V is given as a difference in voltage between the first electrode plate AE and the second electrode plate CE of the one from among the first capacitive deionization device CD1 and the second capacitive deionization device CD2, weak forces attracting ions may lead to a significant reduction in deionization efficiency. When a voltage of greater than about 1.5 V is given as a difference in voltage between the first electrode plate AE and the second electrode plate CE of the one from among the first capacitive deionization device CD1 and the second capacitive deionization device CD2, there may be a large likelihood in water electrolysis, an increase in power consumption, a degradation in electrode plate, and a reduction in process efficiency.

When the deionized water WS(2) is produced from the one from among the first capacitive deionization device CD1 and the second capacitive deionization device CD2, a flow rate of the wastewater WS(1) may range from, for example, about 1.5 L/min to about 3.5 L/min. A reduction in flow rate of the wastewater WS(1) may cause an increase in contact time with the first electrode plates AE and the second electrode plates CE, with the result that there is an increase in deionization effect and a reduction in production of deionized water. Therefore, in consideration of both deionization effect and production, an appropriate flow rate of the wastewater WS(1) may be between about 1.5 L/min and 3.5 L/min as mentioned above.

FIG. 2C illustrates a simplified diagram showing production of concentrated water from one of a first capacitive deionization device and a second capacitive deionization device. FIG. 2C depicts one electrode pair PE as an example.

When the capacitive deionization process for production of the deionized water WS(2) is performed for a certain time as discussed in FIG. 2B, ions may be accumulated on surfaces of the first electrode plate AE and the second electrode plate CE to reach saturation, and then an ion removal rate may be reduced. In this stage, the production of the deionized water WS(2) may be terminated, and the adsorbed ions may be removed by applying an opposite voltage or 0 V to the first electrode plates AE and the second electrode plates CE.

For example, referring to FIG. 2C, when the first electrode plates AE are provided with a negative voltage or 0 V, and when the wastewater WS(1) is supplied, the anions may be desorbed which are adsorbed (or trapped) on the surfaces of the first electrode plates AE to which the positive voltage is applied as discussed in FIG. 2B, and the desorbed anions may be provided in the wastewater WS(1). In addition, when the second electrode plates CE are provided with a positive voltage or 0 V, and when the wastewater WS(1) is supplied, the cations may be desorbed which are adsorbed (or trapped) on the surfaces of the second electrode plates CE to which the negative voltage is applied as discussed in FIG. 2B, and the desorbed cations may be provided in the wastewater WS(1). Therefore, compared to the wastewater WS(1) introduced through the inlet port IP, a wastewater (e.g., concentrated water WS(3)) discharged through the outlet port OP of the chamber CH may include ions whose amount (concentration) is increased. The wastewater (e.g., the concentrated water WS(3)) having an increased ion concentration may be called “concentrated water.” This procedure may be called “production of the concentrated water WS(3).”

A ratio of a flow rate of the deionized water WS(2) to a sum of flow rates of the deionized water WS(2) and the concentrated water WS(3) may range from about 50% to about 80%, for example, from about 66% to about 80%.

The electrical conductivity sensor SN (refer to FIG. 2A) may be used to determine or control a first time Δt1, or a time length until the production of the deionized water WS(2) is interrupted. For example, the electrical conductivity sensor SN may measure in real time an electrical conductivity of the wastewater WS(2) at the outlet port OP of the chamber CH.

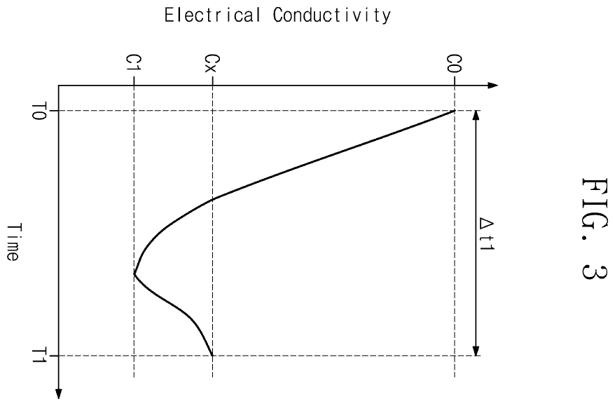

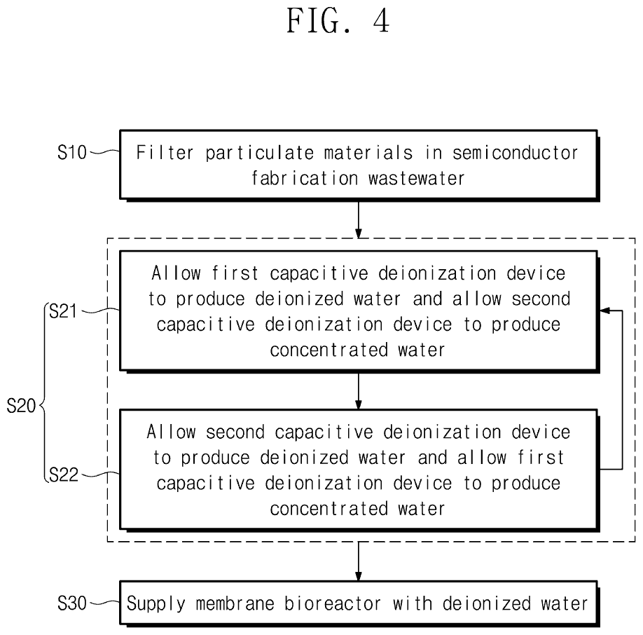

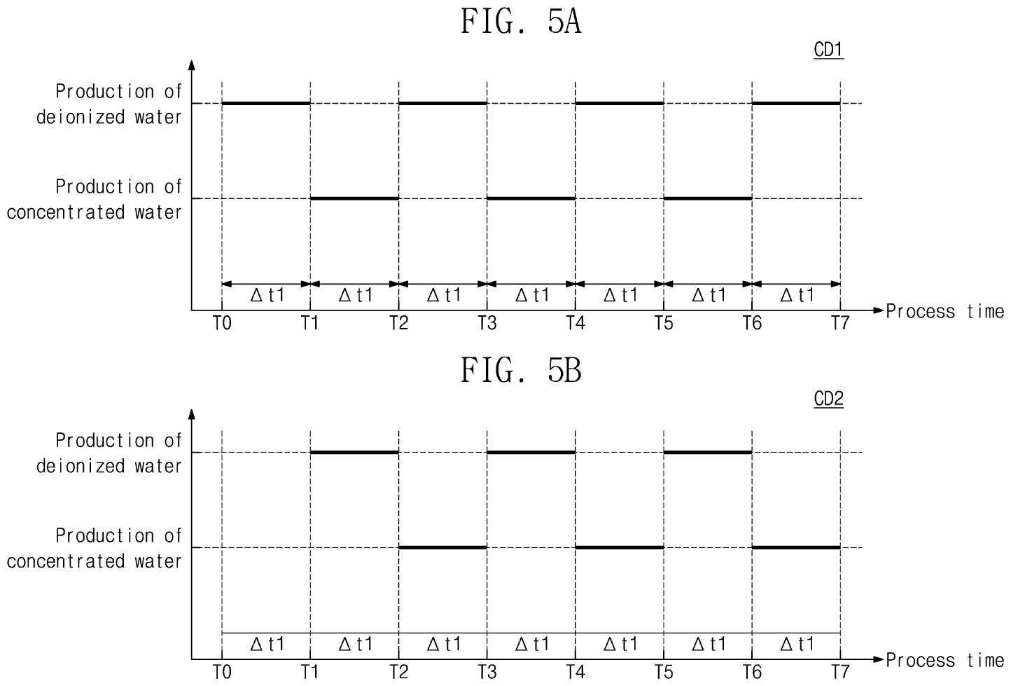

FIG. 3 illustrates a graph showing a change in electrical conductivity of wastewater according to some embodiments of the present disclosure.

Referring to FIG. 3, when the production of the deionized water WS(2) begins, an electrical conductivity of the deionized water WS(2) at the outlet port OP of the chamber CH may gradually decrease to a first value C1 as a minimum value from an initial value C0 at an initial time point TO. This may be caused by the fact that, when the capacitive deionization process is performed, ions may be trapped on the surfaces of the first electrode plate AE and the second electrode plate CE to remove the ions in the deionized WS(2). However, as the capacitive deionization process is executed, ions may be saturated on the surfaces of the first and second electrode plates AE and CE. Thus, even though the capacitive deionization process is continuously carried out, ions may no longer be trapped on the surfaces of the first electrode plate AE and the second electrode plate CE, and ions in the deionized WS(2) may increase to cause the electrical conductivity to rise again from the first value C1 as the minimum value to reach an allowable limit value Cx at a first time point T1. This first time point T1 may be determined as a termination time of the production of deionized water. The first time Δt1, or a time difference between the first time point T1 and the initial time point TO, may range from about 60 seconds to about 300 seconds. The allowable limit value Cx may be lower than the initial value C0 and higher than the first value C1 as the minimum value.

Referring back to FIG. 1, the outlet port OP of the first capacitive deionization device CD1 may be connected to a first deionized water line L31 and a first concentrated water line L41. A valve V31 may be disposed on the first deionized water line L31, and a valve V41 may be disposed on the first concentrated water line L41. The outlet port OP of the second capacitive deionization device CD2 may be connected to a second deionized water line L32 and a second concentrated water line L42. A valve V32 may be disposed on the second deionized water line L32, and a valve V42 may be disposed on the second concentrated water line L42.

The first deionized water line L31 and the second deionized water line L32 may be connected to the membrane bioreactor MB. The membrane bioreactor MB may use microbes (e.g., bacteria) to remove organic materials, nitrogen, phosphorus, and so forth.

In embodiments of the present disclosure, the wastewater treatment system 100 of FIG. 1 may be used to satisfactorily treat (or deionize) the semiconductor fabrication wastewater WS. In embodiments of the present disclosure, the capacitive deionization devices (e.g., the first capacitive deionization device CD1 and the second capacitive deionization device CD2) may be utilized to remove ions in the semiconductor fabrication wastewater WS. Therefore, an applied potential (or voltage) may be adjusted to control ion adsorption-desorption.

FIG. 4 illustrates a flow chart showing a wastewater treatment method for a semiconductor fabrication process according to some embodiments of the present disclosure.

Referring to FIGS. 1 and 4, in a wastewater treatment method according to the present embodiment, particulate materials in the semiconductor fabrication wastewater WS may be filtered (a first operation S10). The first operation S10 may be performed using the filtration device FT of FIG. 1. The first operation S10 may include a first filtration procedure using the first filtering unit F1 and a second filtration procedure using the second filtering unit F2. However, embodiments of the present disclosure are not limited thereto, and three or more filtration procedures may be performed. The wastewater WS may pass through the capacitive deionization devices (e.g., the first capacitive deionization device CD1 and the second capacitive deionization device CD2) to produce deionized water and concentrated water (a second operation S20). The second operation S20 may include allowing the first capacitive deionization device CD1 to produce the deionized water and allowing the second capacitive deionization device CD2 to produce the concentrated water (an operation S21), and allowing the second capacitive deionization device CD2 to produce the deionized water and allowing the first capacitive deionization device CD1 to produce the concentrated water (operation S22). In the operation S21, the first capacitive deionization device CD1 may be controlled (e.g., by at least one controller) to produce the deionized water and the second capacitive deionization device CD2 may be controlled (e.g., by the at least one controller) to produce the concentrated water. In the operation S22, the second capacitive deionization device CD2 may be controlled (e.g., by the at least one controller) to produce the deionized water and the first capacitive deionization device CD1 may be controlled (e.g., by the at least one controller) to produce the concentrated water. The operation S21 and the operation S22 may be repeatedly performed several times. In the second step S20, the deionized water WS(2) and the concentrated water WS(3) may be produced at the same time. As a result, a process yield may increase.

FIG. 5A illustrates a graph showing how a first capacitive deionization device operates over time. FIG. 5B illustrates a graph showing how a second capacitive deionization device operates over time.

Referring to FIGS. 1 to 5B, at the initial time point TO, the valve V22 may be closed (e.g., by the at least one controller) and the valve V21 may be opened (e.g., by the at least one controller). The wastewater WS may be supplied to the first capacitive deionization device CD1. For example, a positive voltage may be applied (e.g., by the at least one controller) to the first electrode plates AE of the first capacitive deionization device CD1 and a negative voltage may be applied (e.g., by the at least one controller) to the second electrode plates CE of the first capacitive deionization device CD1, and accordingly anions and cations in the wastewater WS(1) passing through the first capacitive deionization device CD1 may be removed to produce the deionized water WS(2). It may be possible to measure an electrical conductivity of the wastewater WS(2) discharged through the outlet port OP of the first capacitive deionization device CD1. As shown in FIG. 3, the electrical conductivity may decrease to the first value C1 as the minimum value and then rise again to reach the allowable limit value Cx, and the production of the deionized water WS(2) of the first capacitive deionization device CD1 may be terminated at the first time point T1 at which the electrical conductivity reaches the allowable limit value Cx. For example, the production of the deionized water WS(2) of the first capacitive deionization device CD1 may be achieved during the first time Δt1. This may correspond to a modification of the step S21.

Successively, the valve V22 may be opened at the first time point T1. For example, based on the at least one controller determining that the electrical conductivity reaches the allowable limit value Cx, the controller may control the valve V22 to be opened. In this stage, the valve V21 may also be opened (e.g., by the at least one controller). A portion of the wastewater WS(1) may be supplied through the connection line L21 to the first capacitive deionization device CD1, and another portion of the wastewater WS(1) may be supplied through the connection line L22 to the second capacitive deionization device CD2. In this stage, the pump PP21 and the pump PP22 may be adjusted (e.g., by the at least one controller) to control a flow rate of the wastewater WS(1) supplied to the first capacitive deionization device CD1 and the second capacitive deionization device CD2.

At the first time point T1, a negative voltage or 0V may be applied (e.g., by the at least one controller) to the first electrode plates AE of the first capacitive deionization device CD1 and a positive voltage or 0 V may be applied to the second electrode plates CE of the first capacitive deionization device CD1, thereby desorbing ions adsorbed on the surfaces of the first electrode plates AE and the second electrode plates CE. The desorbed ions may be supplied to the wastewater WS(1) passing through the first capacitive deionization device CD1, thereby producing the concentrated water WS(3).

At the first time point T1, a positive voltage may be applied (e.g., by the at least one controller) to the first electrode plates AE of the second capacitive deionization device CD2 and a negative voltage may be applied (e.g., by the at least one controller) to the second electrode plates CE of the second capacitive deionization device CD2 and, accordingly, anions and cations in the wastewater WS(1) passing through the second capacitive deionization device CD2 may be removed to produce the deionized water WS(2). This may correspond to the operation S22.

The operation S22, in which the first capacitive deionization device CD1 produces the concentrated water WS(3) and the second capacitive deionization device CD2 produces the deionized water WS(2), may be performed during the first time Δt1.

The concentrated water production of the first capacitive deionization device CD1 and the deionized water production of the second capacitive deionization device CD2 may be terminated at a second time point T2 after elapse of the first time Δt1 from the first time point T1. Then, the voltage application modes may be interchanged between the first capacitive deionization device CD1 and the second capacitive deionization device CD2. For example, a positive voltage may be applied (e.g., by the at least one controller) to the first electrode plates AE of the first capacitive deionization device CD1 and a negative voltage may be applied (e.g., by the at least one controller) to the second electrode plates CE of the first capacitive deionization device CD1, and accordingly anions and cations in the wastewater WS(1) passing through the first capacitive deionization device CD1 may be removed to produce the deionized water WS(2). In addition, a negative voltage or 0 V may be applied (e.g., by the at least one controller) to the first electrode plates AE of the second capacitive deionization device CD2 and a positive voltage or 0 V may be applied (e.g., by the at least one controller) to the second electrode plates CE of the second capacitive deionization device CD2 and, accordingly, ions adsorbed on the surfaces of the first electrode plates AE and the second electrode plates CE may be desorbed to produce the concentrated water WS(3). This may correspond to the operation S21.

The operation S21, in which the first capacitive deionization device CD1 produces the deionized water WS(2) and the second capacitive deionization device CD2 produces the concentrated water WS(3), may be performed during the first time Δt1. The operation S22 may be performed again at a third time point T3 after elapse of the first time Δt1 from the second time point T2. The step S21 and the step S22 may be alternately repeated, and each may be performed during the first time Δt1.

The produced deionized water may be supplied to the membrane bioreactor MB (a third operation S30). The produced concentrated water may be discarded. During the operation S21 or the deionized water production of the first capacitive deionization device CD1 and the concentrated water production of the second capacitive deionization device CD2, the valve V31 and the valve V42 of FIG. 1 may be opened (e.g., by the at least one controller) and the valve V41 and the valve V32 of FIG. 1 may be closed (e.g., by the at least one controller) to supply the membrane bioreactor MB with deionized water of the first capacitive deionization device CD1. In contrast, during the operation S22 or the concentration water production of the first capacitive deionization device CD1 and the deionized water production of the second capacitive deionization device CD2, the valve V41 and the valve V32 of FIG. 1 may be opened (e.g., by the at least one controller) and the valve V31 and the valve V42 of FIG. 1 may be closed (e.g., by the at least one controller) to supply the membrane bioreactor MB with concentrated water of the second capacitive deionization device CD2. As discussed above, a wastewater pathway may be adjusted by controlling (e.g., by the at least one controller) on/off of the valve V31, the valve V32, the valve V41, and the valve V42.

The pump PP21 and the pump PP22 may be used (e.g., by the at least one controller) to adjust an amount of each of the deionized water WS(2) and the concentrated water WS(3) respectively produced from the first capacitive deionization device CD1 and the second capacitive deionization device CD2. Flow rates of the deionized water WS(2) and the concentrated water WS(3) may be used to calculate (e.g., by the at least one controller) a wastewater recovery rate. The recovery rate of the wastewater WS(1) or a ratio of the flow rate of the deionized water WS(2) to a sum of the flow rates of the deionized water WS(2) and the concentrated water WS(3) may range, for example, from about 50% to about 80%. Recovery rate (%)=(flow rate (L) of deionized water/total flow rate (L))×100.

### Experimental Example

The inventors investigated how an ion removal rate was changed with kinds of cation and operating voltages of the first and second capacitive deionization devices according to embodiments of the present disclosure. The inventors carried out an experiment as discussed below. The following were concentrations of main cations in a semiconductor fabrication wastewater (raw wastewater) supplied to a capacitive deionization device.
Na⁺: 330 mg/L, NH₄⁺: 218 mg/L, Ca²⁺: 141 mg/L

Each of first and second capacitive deionization devices may include 200 electrode pairs. Operating voltages of each of first and second capacitive deionization devices may be about 200V, 250V, and 300V. The operating voltage can be divided by the number of the electrode pairs to obtain a difference in voltage between a pair of first and second electrode plates. For example, 200V is divided by 200 to obtain 1V. 250V is divided by 200 to obtain 1.25V. 300V is divided by 200 to obtain 1.5V. That is, a difference in voltage between a pair of first and second electrode plates may be about 1.0V, 1.25V, and 1.5V. Other operating conditions of the first and second capacitive deionization devices were as follows.
(1) Recovery rate: 66%
(2) Temperature: room temperature
(3) Production time of deionized water/concentrated water: 120 seconds
(4) Flow rate of deionized water: 2.5 L/min

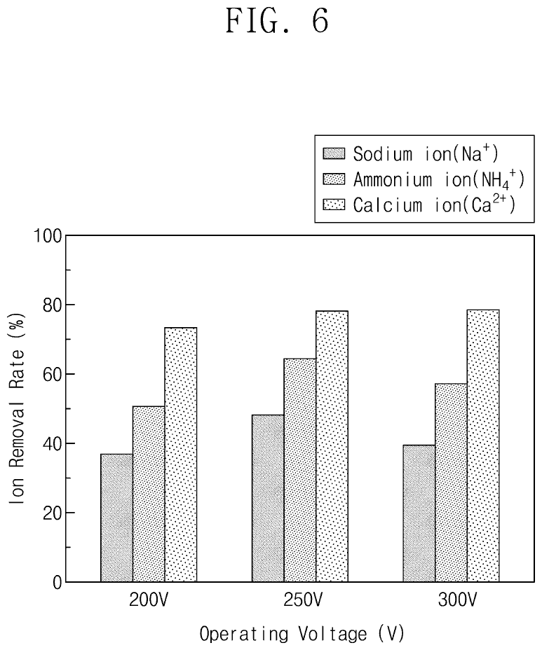

Ion chromatography was employed to analyze concentrations of cations in a raw wastewater and concentrations of cations in deionized water, and based on these, an ion removal rate for each cation was evaluated and presented in FIG. 6. FIG. 6 illustrates a graph showing how ion removal rates depend on kinds of cation and operating voltages of capacitive deionization devices according to embodiments of the present disclosure. Referring to FIG. 6, in a capacitive deionization device according to the present embodiment, when an operating voltage was about 300V, a removal rate of calcium ion or divalent cation was about 78%, and removal rates of sodium ion and ammonium ion or monovalent cations were about 39% and about 57%, respectively. When operation voltages were about 200V, 250V, and 300V, or when differences in voltage between first and second electrode plates were about 1.0V, 1.25V, and 1.5V, it was ascertained that a removal rate of calcium ion was greater than that of ammonium ion and that of sodium ion. When Mathematical Formula 1 above was used to calculate Ca²⁺/Na⁺ selectivity, the selectivity was about 2.36 to 2.79.

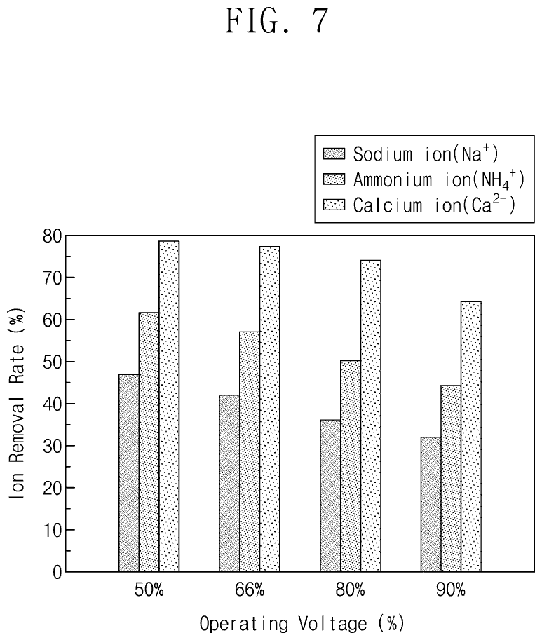

Under the conditions mentioned above, recovery rates of capacitive deionization devices and ion removal rates depending on kinds of cation were investigated and presented in FIG. 7. Referring to FIG. 7, a preferable recovery rate was about 66% to 80%. An increase in recovery rate may cause a reduction in production amount of concentrated water and a reduction in ion removal rate. When the recovery rate was about 50%, a ratio of concentrated water and deionized water was about 1:1 and a burden of concentrated water production was increased. When the recovery rate was about 66%, a ratio of concentrated water and deionized water was about 1:2 and a reduction in production of concentrated water was then achieved. In addition, there was no significant reduction in removal rate, and it was then not preferable to apply an operating condition of recovery rate more than about 66%. When the recovery rate was increased to about 80%, a removal rate of Ca²⁺ was relatively excellent (75%), but when the recovery rate was 90%, a removal rate of Ca²⁺ was abruptly decreased to increase the likelihood of scale formation.

According to embodiments of the present disclosure, the wastewater treatment system 100 may further include at least one controller. The at least one controller may include at least one processor and memory storing computer instructions. The computer instructions may be configured to, when executed by the at least one processor, cause the at least one controller to perform its functions. According to embodiments of the present disclosure, the at least one controller may include a plurality of controllers. For example, the at least one controller may include a controller outside of the first capacitive deionization device CD1 and the second capacitive deionization device CD2, and/or may include the first voltage controllers CR1 and the second voltage controllers CR2 of the first capacitive deionization device CD1 and the second capacitive deionization device CD2.

According to embodiments of the present disclosure, the at least one controller may be configured to control various components of the wastewater treatment system to perform their functions. For example, the controller may control valves (e.g., the first valve V1, the valve V21, the valve V22, the valve V31, the valve V41, the valve v32, and the valve v42), pumps (e.g., the first pump PP1, the pump PP21, the pump V22, the pump V31, the pump V41, the pump V32, and the pump V42), the first electrode plates AE, the second electrode plates CE, the first voltage controllers CR1, the second voltage controllers CR2, the membrane bioreactor, etc., to perform their respective functions. The at least one controller may also receive information from sensors (e.g., the electrical conductivity sensor SN) to make determinations (e.g., determinations described in the present disclosure) and/or to cause functions of the wastewater treatment system 100 to be performed. The at least one controller may control the various components to perform methods (e.g., the wastewater treatment method of FIG. 4) of embodiments of the present disclosure including, for example, the operations described above with reference to FIGS. 1-5B.

In a wastewater treatment system for a semiconductor fabrication process and a wastewater treatment method using the same, according to embodiments of the present disclosure, calcium ions may be effectively removed to control or reduce hardness of semiconductor fabrication wastewater. In addition, the semiconductor fabrication wastewater may not only be satisfactorily treated (or deionized), but also concentrated, thereby increasing process efficiency and improving productivity.

In embodiments of the present disclosure, a capacitive deionization device may be used to remove ions from a semiconductor fabrication wastewater. Accordingly, the semiconductor fabrication wastewater may be treated or deionized economically and eco-friendly.

Although non-limiting example embodiment have been described in connection with the drawings, it will be understood to those skilled in the art that various substitution, modifications, and changes may be made without departing from the spirit and scope of the present disclosure.

What is claimed is:

1. A wastewater treatment system, comprising:
a filter that is configured to filter a semiconductor fabrication wastewater; and
a first capacitive deionizer and a second capacitive deionizer that are connected in parallel to the filter,
wherein one from among the first capacitive deionizer and the second capacitive deionizer is configured to produce deionized water while the other from among the first capacitive deionizer and the second capacitive deionizer is configured to simultaneously produce concentrated water.

2. The wastewater treatment system of claim 1, wherein each of the first capacitive deionizer and the second capacitive deionizer comprises:
a chamber that comprises an inlet port and an outlet port; and
a plurality of electrode pairs in the chamber, each of the plurality of electrode pairs comprising a first electrode plate and a second electrode plate that are adjacent to each other,
wherein the wastewater treatment system further comprises at least one controller configured to adjust a voltage applied to the first electrode plate and the second electrode plate of each of the first capacitive deionizer and the second capacitive deionizer,
wherein the at least one controller is further configured to:
cause a positive voltage to be applied to the first electrode plate, of the one from among the first capacitive deionizer and the second capacitive deionizer, and cause a negative voltage to be applied to the second electrode plate, of the one from among the first capacitive deionizer and the second capacitive deionizer, while the one from among the first capacitive deionizer and the second capacitive deionizer produces the deionized water; and
cause a negative voltage or 0V to be applied to the first electrode plate, of the other from among the first capacitive deionizer and the second capacitive deionizer, and cause a positive voltage or 0V to be applied to the second electrode plate, of the other from among the first capacitive deionizer and the second capacitive deionizer, while the other from among the first capacitive deionizer and the second capacitive deionizer produces the concentrated water.

3. The wastewater treatment system of claim 2, wherein the at least one controller is further configured to cause a difference in voltage between the first electrode plate and the second electrode plate of the one from among the first capacitive deionizer and the second capacitive deionizer to be in a range of 1.0 V to 1.5 V while the one from among the first capacitive deionizer and the second capacitive deionizer produces the deionized water.

4. The wastewater treatment system of claim 2, wherein the at least one controller is further configured to control a flow rate of the semiconductor fabrication wastewater in the chamber of the one from among the first capacitive deionizer and the second capacitive deionizer to be in a range of 1.5 L/min to 3.5 L/min while the one from among the first capacitive deionizer and the second capacitive deionizer produces the deionized water.

5. The wastewater treatment system of claim 2, wherein the first electrode plate and the second electrode plate comprise activated carbon.

6. The wastewater treatment system of claim 2, wherein each of the first capacitive deionizer and the second capacitive deionizer further comprises an electrical conductivity sensor, at the outlet port of the chamber, that is configured to measure an electrical conductivity of water,
wherein the at least one controller is further configured to terminate a production of the deionized water in the one from among the first capacitive deionizer and the second capacitive deionizer based on the electrical conductivity sensor measuring that an electrical conductivity of the deionized water decreases to a minimum value and then rises to reach an allowable limit value, and
wherein the at least one controller is further configured to terminate the production of the deionized water at a time that the allowable limit value is reached.

7. The wastewater treatment system of claim 1, wherein an ion concentration of the deionized water is less than an ion concentration of the semiconductor fabrication wastewater passing through the filter, and
wherein an ion concentration of the concentrated water is greater than the ion concentration of the semiconductor fabrication wastewater passing through the filter.

8. The wastewater treatment system of claim 7, wherein the semiconductor fabrication wastewater passing through the filter and the deionized water comprise a calcium ion,
wherein the calcium ion in the semiconductor fabrication wastewater passing through the filter has a concentration of 100 ppm to 500 ppm, and
wherein the calcium ion in the deionized water has a concentration of 0 ppm to 75 ppm.

9. The wastewater treatment system of claim 1, wherein the filter comprises:
a first filter that has a first pore size; and
a second filter that has a second pore size that is smaller than the first pore size.

10. The wastewater treatment system of claim 9, wherein the first pore size is in a range of 0.6 μm to 3 μm, and
wherein the second pore size is in a range of 0.1 μm to 0.5 μm.

11. The wastewater treatment system of claim 1, wherein the semiconductor fabrication wastewater comprises monovalent cations and divalent cations, and
wherein the one from among the first capacitive deionizer and the second capacitive deionizer is configured to remove the divalent cations more than the monovalent cations while producing the deionized water.

12. The wastewater treatment system of claim 1, wherein a ratio of a flow rate of the deionized water to a sum of flow rates of the deionized water and the concentrated water is in a range of 50% to 80%.

13. The wastewater treatment system of claim 1, further comprising a membrane bioreactor that is configured to be supplied with the deionized water.

14. A wastewater treatment system, comprising:
a filter configured to filter a semiconductor fabrication wastewater;
at least one capacitive deionizer connected to the filter and configured to produce deionized water;
a membrane bioreactor connected to the at least one capacitive deionizer; and
at least one controller,
wherein the at least one capacitive deionizer comprises:
a chamber that comprises an inlet port and an outlet port;
a plurality of electrode pairs in the chamber, each of the plurality of electrode pairs comprising a first electrode plate and a second electrode plate that are adjacent to each other,
wherein the at least one controller is configured to adjust a voltage applied to the first electrode plate and the second electrode plate, and
wherein the at least one controller is configured to cause a difference in voltage between the first electrode plate and the second electrode plate of the at least one capacitive deionizer to be in a range of 1.0 V to 1.5 V while the at least one capacitive deionizer produces the deionized water.

15. The wastewater treatment system of claim 14, wherein the semiconductor fabrication wastewater comprises monovalent cations and divalent cations, and
wherein the at least one capacitive deionizer is configured to remove the divalent cations more than the monovalent cations.

16. The wastewater treatment system of claim 14, wherein the at least one capacitive deionizer comprises a first capacitive deionizer and a second capacitive deionizer that are connected in parallel to the filter, and
wherein one from among the first capacitive deionizer and the second capacitive deionizer is configured to produce the deionized water while the other from among the first capacitive deionizer and the second capacitive deionizer is configured to simultaneously produce concentrated water.

17. The wastewater treatment system of claim 16, wherein each of the first capacitive deionizer and the second capacitive deionizer further comprises an electrical conductivity sensor, at the outlet port of the chamber, that is configured to measure an electrical conductivity of water,
wherein the at least one controller is further configured to terminate a production of the deionized water in the one from among the first capacitive deionizer and the second capacitive deionizer based on the electrical conductivity sensor measuring that an electrical conductivity of the deionized water decreases to a minimum value and then rises to reach an allowable limit value, and
wherein the at least one controller is further configured to terminate the production of the deionized water at a time the allowable limit value is reached.

18. The wastewater treatment system of claim 16, wherein the at least one controller is further configured to control a flow rate of the semiconductor fabrication wastewater in the chamber of the one from among the first capacitive deionizer and the second capacitive deionizer to be in a range of 1.5 L/min to 3.5 L/min while the one from among the first capacitive deionizer and the second capacitive deionizer produces the deionized water.

19. A wastewater treatment method, comprising:
filtering, by a filter, particulate materials in a semiconductor fabrication wastewater;
producing, by a first capacitive deionizer, deionized water;
producing, by a second capacitive deionizer, concentrated water; and
supplying a membrane bioreactor with the deionized water.

20. The method of claim 19, further comprising, after the producing the deionized water by the first capacitive deionizer and the producing the concentrated water by the second capacitive deionizer:
producing, by the second capacitive deionizer, the deionized water; and
producing, by the first capacitive deionizer, the concentrated water.
